(19) United States
(12) Patent Application Publication
(10) Pub. No.: US 2016/0209974 A1
(43) Pub. Date: Jul. 21, 2016

(54) TOUCH RECOGNITION METHOD FOR DISPLAY DEVICE AND DISPLAY DEVICE USING THE SAME

(71) Applicant: Samsung Display Co., Ltd., Yongin-City (KR)

(72) Inventors: Kyung Hyun BAEK, Suwon-si (KR); Yoon Jee SHIN, Ulsan (KR); Seung Rok LEE, Yongin-si (KR)

(21) Appl. No.: 14/794,622

(22) Filed: Jul. 8, 2015

(30) Foreign Application Priority Data
Jan. 20, 2015 (KR) 10-2015-0009418

(51) Int. Cl. G06F 3/041; G06F 3/044

(52) U.S. Cl. CPC G06F 3/0416; G06F 3/0412; G06F 3/044; G06F 2203/04102; G06F 2203/04111

(57) ABSTRACT

Provided is a display device including: a display panel including a plurality of touch sensors; a sensing signal processor configured to generate a sensing signal including whether the plurality of touch sensors are touched and a touch time; and a signal controller configured to sequentially sensing a first touch starting timing, a first touch ending timing, a second touch starting timing, and a second touch ending timing based on the sensing signal and configured to measure a first touch discontinuous period between the first touch ending timing and the second touch starting timing to recognize a touch, wherein the signal controller is configured to recognize a touch from the first touch starting timing to the second touch ending timing as a continued touch when the first touch discontinuous period is equal to or less than a predetermined first threshold time.

### CROSS-REFERENCE TO RELATED APPLICATION

This application claims priority to and the benefit of Korean Patent Application No. 10-2015-0009418 filed in the Korean Intellectual Property Office on Jan. 20, 2015, the entire contents of which are incorporated herein by reference.

### BACKGROUND

(a) Field

The present application relates to a touch recognition method for a display device and a display device using the same, and more particularly, to a technology of accurately recognizing a touch of a display device including a touch panel.

(b) Description of the Related Art

Display devices, such as a liquid crystal display (LCD), an organic light emitting diode display (OLED display), and an electrophoretic display, include a field generating electrode and an electro-optical active layer. For example, the organic light emitting diode display includes an organic emission layer as the electro-optical active layer. The electric field generating electrode may be connected to a switching device such as a thin film transistor, or the like, to receive a data signal, and the electro-optical active layer converts the data signal into an optical signal to display an image.

In recent, the display device may include a touch sensing function which interacts with a user, in addition to an image displaying function. The touch sensing function senses a change in pressure, charge, light, and the like which are applied to a screen by a display device at a user touch point on a screen to which a user touches or when a user approaches or contacts his/her finger, a touch pen, or the like, to the screen so as to write characters or draw pictures. The touch sensing function finds out contact information on whether objects approach or contact a screen and the contact positions, and the like. The display device may receive an image signal and display an image, based on the contact information.

The touch sensing function may be implemented by a touch sensor. The touch sensor may be classified into various types, such as a resistive type, a capacitive type, an electro-magnetic type (EM), and an optical type.

Among those, the capacitive type touch sensor includes a plurality of touch electrodes which may transfer sensing signals. The touch electrode may also form a sensing capacitor along with another touch electrode (mutual-capacitor type) and may also form the sensing capacitor along with external objects (self-capacitor type). When a conductor like the user touch point approaches or contacts the touch sensor, capacitance or a charged charge amount of the sensing capacitor is changed. It may find out whether objects approach or contact a screen and the contact positions, and the like based on the change.

A plurality of touch electrodes may he disposed in a touch sensing area in which a contact may he sensed and may be connected to a plurality of touch wirings which transfers sensing signals. The touch wiring may he positioned within the touch sensing area and may also be disposed within a non-sensing area around the touch sensing area. The touch wiring may transfer a sensing input signal to the touch electrode or transfer a sensing. output signal of the touch electrode which is generated depending on a touch to a touch driver.

The touch sensor may he used, with being embedded in the display device (in-cell type), directly formed on an outer surface of the display device (on-cell type), or adding a separate touch sensor unit to the display device (add-on cell type). The display device including the touch sensor finds out whether a user touch point of a user, a touch pen, etc., touch a screen and information on touched positions, thereby displaying images.

When as the display panel of the display device including the touch sensor, a glass substrate which is heavy and easily damaged is used, it has a limitation in portability and implementation of a large screen display. Therefore, a display device which uses a plastic substrate which is light, strong against impact, and flexible as the substrate of the display panel has been developed in recent years.

However, the flexible display device is bent and thus the touched surface is bent, such that the touch may not be continuously recognized even though the touch is a continuous touch.

The above information disclosed in this Background section is only for enhancement of understanding of the background and therefore it may contain information that does not form the prior art that is already known in this country to a person of ordinary skill in the art.

### SUMMARY

Embodiments have been made in an effort to provide a touch recognition method for a display device and a display device using the same having features of increasing a touch recognition rate of a flexible display device including a touch sensor.

The technical features to be achieved by the inventive concept are not limited to the above-mentioned technical features. That is, other technical features that are not mentioned may be understood by those skilled in the art to which the present application pertains from the following description

An exemplary embodiment provides a display device including: a display panel including a plurality of touch sensors; a sensing signal processor configured to generate a sensing signal including whether the plurality of touch sensors are touched and a touch time; and a signal controller configured to sequentially sense a first touch starting timing, a first touch ending timing, a second touch starting timing, and a second touch ending timing based on the sensing signal and configured to measure a first touch discontinuous period between the first touch ending timing and the second touch starting timing to recognize a touch, wherein the signal controller is configured to recognize a touch from the first touch starting timing to the second touch ending timing as a continued touch when the first touch discontinuous period is equal to or less than a predetermined first threshold time.

The signal controller may be configured to recognize a touch from the first touch starting timing to the second touch ending timing as the continued touch when a touch length from the first touch starting timing to the first touch ending timing is equal to or more than a reference length.

The second touch ending timing may be sensed as exceeding the first threshold time and the signal controller may be configured to recognize the touch from the first touch starting timing to the second touch ending timing as the continued touch.

The signal controller may be configured to sequentially sense the first touch starting timing, the first touch ending timing, the second touch starting timing, the second touch ending timing, a third touch starting timing, and a third touch ending timing and measure the first touch discontinuous period and a second touch discontinuous period between the second touch ending timing and the third touch starting timing, and recognize the touch from the first touch starting timing to the third touch ending timing as the continued touch when the first touch starting timing, the first touch ending timing, the first touch discontinuous period, the second touch starting. timing, the second touch ending timing, the second touch discontinuous period, the third touch starting timing, and a third touch ending timing which are sequentially formed are equal to or less than a predetermined second threshold time.

The signal controller may be configured to recognize the touch within a time from the first touch starting timing to the third touch ending timing as the continued touch when the first touch starting timing to the third touch ending timing which are sequentially sensed is equal to or more than a predetermined reference frequency.

The display panel may be a flexible panel which is bent in a concave or convex shape.

Another exemplary embodiment provides a touch recognition method for a display device including a display panel including a plurality of touch sensors, a sensing signal processor generating a sensing signal including whether the plurality of touch sensors are touched and a touch time; and a signal controller recognizing a touch based on the sensing signal, the touch recognition method including: sequentially sensing a first touch starting timing, a first touch ending timing, a second touch starting timing, and a second touch ending timing; measuring a first touch discontinuous period between the first touch ending timing and the second touch starting timing; and recognizing a touch from the first touch starting timing to the second touch ending timing as a continued touch when the first touch discontinuous period is equal to or less than a predetermined first threshold time.

In the recognizing, the touch from the first touch starting timing to the second touch ending timing may be recognized as the continued touch when a touch length from the first touch starting timing to the first touch ending timing is equal to or more than a reference length.

The second touch ending timing may be sensed, exceeding the first threshold time, and in the recognizing, the touch from the first touch starting timing to the second touch ending timing may be recognized as the continued touch.

The touch recognition method may further include: sensing a third touch starting timing and a third touch ending timing; and measuring a second touch discontinuous period between the second touch ending timing and the third touch starting timing, wherein in the recognizing, the touch from the first touch starting timing to the third touch ending timing may he recognized as the continued touch when the first touch starting timing, the first touch ending timing, the first touch discontinuous period, the second touch starting timing, the second touch ending timing, the second touch discontinuous period, the third touch starting timing, and a third touch ending timing which are sequentially formed are equal to or less than a predetermined second threshold time.

In the recognizing, the touch within a time from the first touch starting timing to the third touch ending timing may be recognized as the continued touch when the first touch starting timing to the third touch ending timing which are sequentially sensed is equal to or more than a predetermined reference frequency.

The display panel may be a flexible panel which is bent in a concave or convex shape.

According to the touch recognition method for the display device and the display device using the same in accordance with an exemplary embodiment, it is possible to increase the touch recognition rate of the flexible display device including the touch sensor.

### BRIEF DESCRIPTION OF THE DRAWINGS

FIGS. 1 and 2 are diagrams illustrating a configuration of a display device according to an exemplary embodiment.

FIG. 3 is a diagram illustrating a configuration of a display panel according to an exemplary embodiment.

FIG. 4 is a front view illustrating a touch recognition method according to an exemplary embodiment.

FIG. 5 is a plan view illustrating the touch recognition method according to the exemplary embodiment.

FIG. 6 is a front view illustrating a touch recognition method according to another exemplary embodiment.

FIG. 7 is a plan view illustrating the touch recognition method according to another exemplary embodiment.

FIG. 8 is a flow chart illustrating a recognition method for a display device according to an exemplary embodiment.

### DETAILED DESCRIPTION OF THE EMBODIMENTS

Hereinafter, embodiments will be described in more detail with reference to the accompanying drawings. The same or similar reference numerals will be used to describe the same or like components and an overlapped description thereof will be omitted. Terms “modules”, and “units” for components used in the following description are used only in order to easily make a specification. Therefore, the above-mentioned terms do not have meanings or roles that distinguish from each other in themselves. Further, when it is determined that the detailed description of the known art related to the inventive concept may obscure the gist of the inventive concept. the detailed description thereof will be omitted. In addition, the accompanying drawings are provided to easily understand the technical spirit of the inventive concept disclosed in the present specification, and therefore the technical spirit is not limited to the accompany drawings. Therefore, it is to be construed that the accompanying drawings include all modifications, equivalents, and replacements included in the technical spirit and the technical scope disclosed in the present specification.

Terms including an ordinal number such as ‘first’, ‘second’, etc. can be used to describe various components, but the components are not to be construed as being limited to the terms. The terms are used to distinguish one component from another component.

It is to he understood that when one component is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Singular forms are to include plural forms unless the context clearly indicates otherwise.

It will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof.

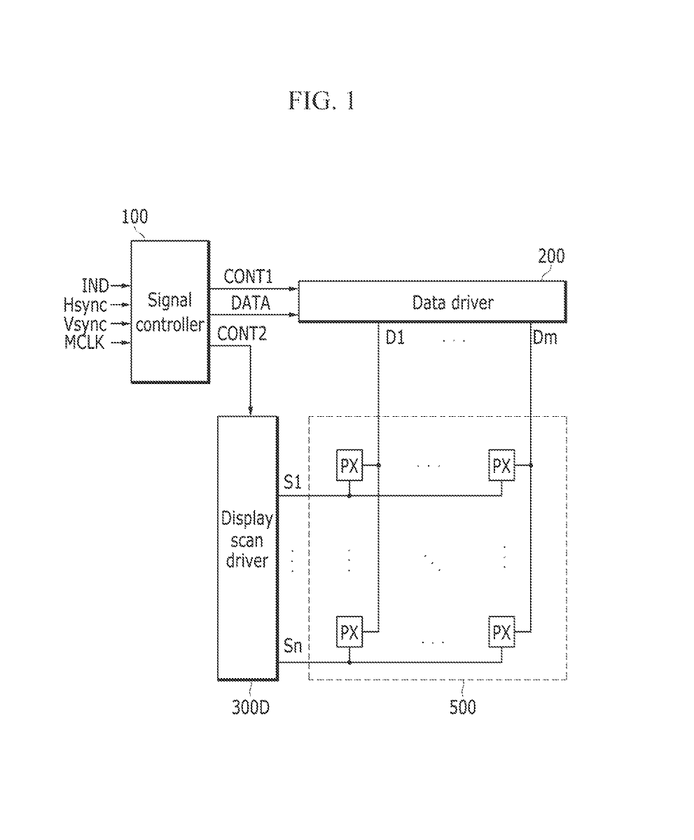

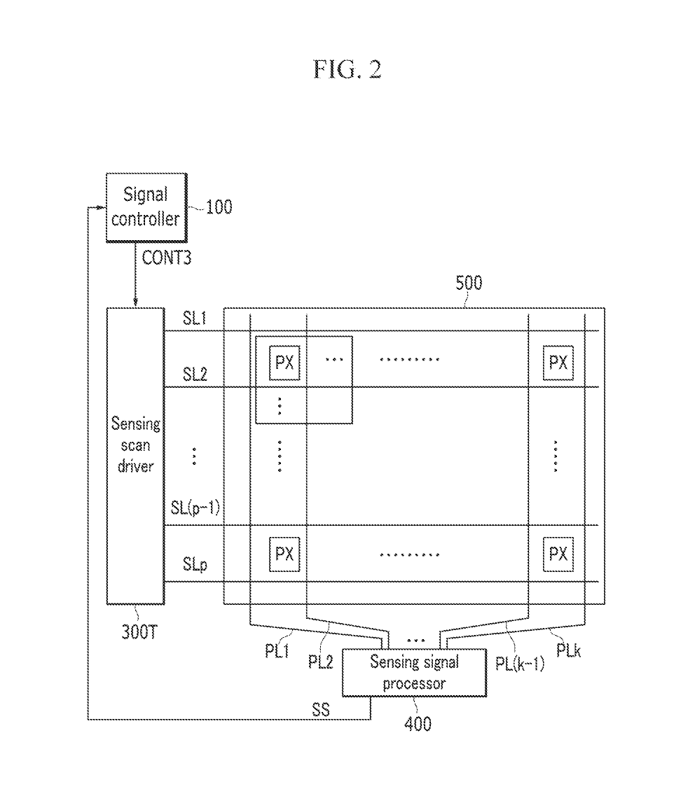

FIGS. 1 and 2 are diagrams illustrating a configuration of a display device according to an exemplary embodiment.

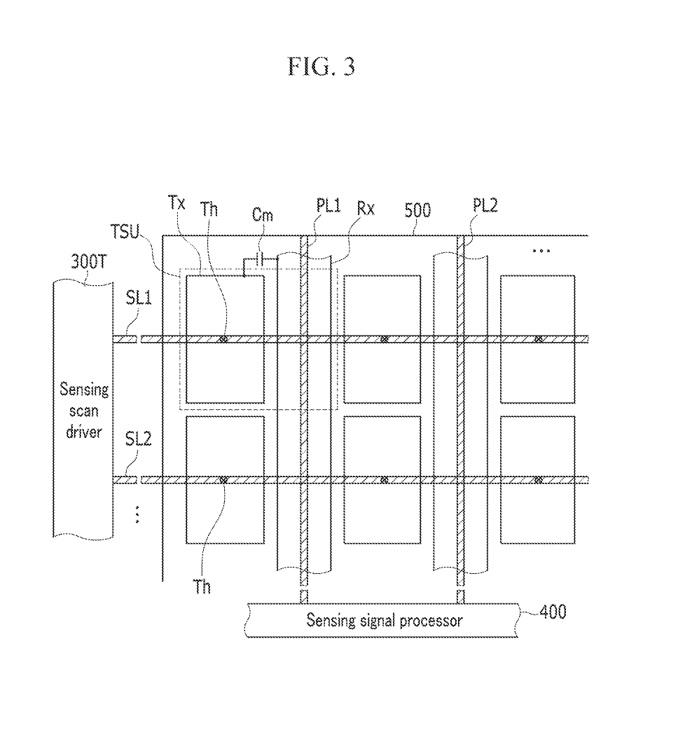

FIG. 3 illustrates a configuration of a display panel according to an exemplary embodiment.

Hereinafter, the display device according to the exemplary embodiment will be described with reference to FIGS. 1 to 3.

As illustrated in FIGS. 1 and 2, a display device 1 includes a plurality of scanning lines S1 to Sn, a plurality of data lines D1 to Dm, a plurality of sensing input signal lines SL1 to SLp, a plurality of sensing output signal lines PL1 to PLk, a signal controller 100, a data driver 200, a display scan driver 300D, a sensing scan driver 300T, a sensing signal processor 400, and a display panel 500.

As illustrated in FIG. 1, the plurality of scanning lines S1 to Sn (n is a natural number) are arranged in a vertical direction and the plurality of scanning lines S1 to Sn extend in a horizontal direction. The plurality of data lines D1 to Dm (m is a natural number) are arranged in a horizontal direction and the plurality of data lines D1 to Dm extend in a vertical direction.

The display panel 500 includes a plurality of pixels PXs which are connected to the plurality of scanning lines S1 to Sn and the plurality of data lines D1 to Dm and arranged in approximately a matrix form. For convenience of explanation, FIGS. 1 and 2 illustrate that the display panel 500 is flat, but the display panel 500 may be bent in a concave shape a convex shape, a wave shape, or the like, including a flexible panel.

The display scan driver 300D is connected to the plurality of scan lines S1 and Sn and sequentially applies a plurality of scan signals S[1] to S[n] to the plurality of scan lines S1 to Sn depending on a scan control signal CONT2.

The data driver 200 is connected to the plurality of data lines D1 to Dm. The data driver 200 generates a plurality of data signals (e.g., data voltage corresponding to an input image data DATA.

The signal controller 100 receives an external input data InD and a synchronization signal and generates a data driving control signal CONT1, the display scan control signal CONT2, a sensing scan control signal CONT3, and the image data DATA. The external input data InD includes luminance information of each pixel PXs, in which the luminance has a defined number, for example, 1024 (=2¹⁰), 256 (=2⁸), or 64 (=2⁶) grays. The synchronization signal includes a horizontal synchronizing signal Hsync, a vertical synchronization signal Vsync, and a main clock signal MCLK. The signal controller 100 identifies the external input data InD in a frame unit depending on the vertical synchronization signal Vsync. Further, the signal controller 100 identifies the external input data InD in a scan line unit depending on the horizontal synchronizing signal Hsync to generate the image data DATA.

The pixel PX is a unit displaying an image, and one pixel PX may uniquely display (spatial division) one of primary colors or a plurality of pixels PXs may alternately display (temporal division) the primary colors over time to display a desired color by the spatial and temporal sum of these primary colors. The pixel PX receives a data signal from a corresponding data line in synchronization with the corresponding scan signal.

The data signal input to the pixel PX is written in the pixel PX depending on the scan signal supplied through the scan line.

As illustrated in FIG. 2, the plurality of sensing input signal lines SL1-SLp (p is a natural number) are arranged in a vertical direction and the plurality of sensing input signal lines SL1 to SLp extend in a horizontal direction. A plurality of sensing output signal lines PL1 PLk (k is a natural number) are arranged in a horizontal direction and the plurality of sensing output signal lines PL1 to PLk extend in a vertical direction. The plurality of touch sensors TSUs are connected to the corresponding sensing input signal lines SL1 to SLp and the corresponding sensing output signal lines PL1 to PLk. The plurality of pixels PXs may be arranged in a matrix form.

The display panel 500 is connected to the plurality of sensing input signal lines SL1 to SLp and the sensing output signal lines PL1 to PLk and includes the plurality of pixels PXs and the touch sensors TSU which are arranged in approximately a matrix form.

The sensing input signal lines SL1 to SLp are connected to the sensing scan driver 300T and may extend to be approximately parallel with each other. The sensing input signal lines SL1 to SLp may transfer the sensing input signal received from the sensing scan driver 300T. The sensing input signal may have various waveforms and voltage levels.

The sensing output signal lines PL1 to PLk are connected to the sensing signal processor 400 and may extend to be approximately parallel with each other while intersecting the sensing input signal lines SL1 to SLp. The sensing output signal generated from the touch sensor TSU depending on the touch of the display panel 500 may be applied to the sensing output signal lines PL1 to PLk.

The sensing scan driver 300T applies the sensing input signal (e.g., sensing input voltage) corresponding to the holding position to the sensing input signal lines SL1 to SLp, depending on the sensing scan control signal CONT3. In this case, the application of the sensing input signal may be sequentially made.

The sensing signal processor 400 generates a sensing signal SS including touch information such as whether the touch sensor TSU is touched, the touch position, and the like, based on the sensing output signal. FIG. 2 illustrates the sensing signal processor 400 separately from the signal controller 100, but the exemplary embodiment is not limited thereto, and therefore the sensing signal processor 400 may be included in the signal controller 100.

The touch sensor TSU may detect a touch of a user who uses any type of pointing tools such as a portion of a user's body (e.g., finger) and a stylus. The touch sensor TSU is a capacitive type and may generate the sensing output signal depending on the touch. As illustrated in FIG. 3 one touch sensor TSU may be positioned at a portion where one sensing input signal line SL1 and one sensing output signal line PL2 intersect each other. A length of one side of the touch sensor TSU may be approximately several mm, for example, approximately 4 to 5 mm. A size of the touch sensor TSU may be changed depending on a touched area when an object is touched to the display panel 500.

Further, the plurality of pixels PXs may be positioned in an area of one touch sensor TSU. For example, tens to hundreds of pixel PX columns may be disposed in the area of one touch sensor TSU along a row direction or a column direction, However, a density of the pixel PX corresponding to one touch sensor TSU is not limited thereto and therefore may be variously changed depending on the resolution of the display device.

As illustrated in FIG. 3, the touch sensor TSU includes a sensing capacitor Cm which is formed of the sensing input signal line SL1 and the sensing output signal line PL1. The sensing capacitor Cm may include an overlap sensing capacitor configured by overlapping between the sensing input signal line SL1 and the sensing output signal line PL1 or a fringe sensing capacitor configured by allowing the sensing input signal line SL2 and the sensing output signal line PL1 to be adjacent to each other without being overlapped with each other. The touch sensor TSU may receive the sensing input signal transferred by the sensing input signal line SL1 to sense a change in charge amount of the sensing capacitor Cm due to the touch of the external object and generate the sensed change as an output signal. Describing in detail, when the sensing input signal is input to the touch sensor TSU, the sensing capacitor Cm is charged with a predetermined charge amount and the charge amount changed depending on the touch is output to the sensing output signal line PL1 as the sensing output signal. That is, when the touch of the external object is present, the charge amount charged in the sensing capacitor Cm is changed and thus the sensing output signal is output to the sensing output signal line PL1. A voltage level of the sensing output signal when an object is touched to the display panel 500 may be smaller than a voltage level of the sensing output signal when an object is not touched.

A sensing input electrode Tx may he arranged in a matrix form. The plurality of sensing input electrodes Txs which are arranged in a column direction forms one sensing input electrode column and the plurality of sensing input electrodes Txs which are arranged in a row direction form one sensing input electrode row. The plurality of sensing input electrodes Txs which are positioned in one sensing input electrode column may he connected to each other. As Illustrated in FIG. 3, a shape of each sensing input electrode Tx may be a quadrangle but is not limited thereto and therefore each sensing input electrode may have various shapes. A length of one side of each sensing input electrode Tx may be approximately several mm, but the size thereof may be changed depending on the touch object and the touch method.

A sensing output electrode Rx may extend in a column direction and a plurality of sensing output electrodes Rxs which are arranged in a row direction may be disposed at a predetermined interval. Each sensing output electrode Rx is disposed between the two adjacent sensing input electrode columns and the sensing output electrode Rx and the sensing input electrode Tx may be alternately arranged in a row direction.

The sensing output electrode Rx and the sensing input electrode Tx which are adjacent to each other on a plane may face each other at a predetermined interval. The sensing output electrode Rx and the sensing input electrode Tx which are adjacent to each other forms one touch sensor TSU including the sensing capacitor Cm. When the touch is applied from the outside, the change amount of the sensing capacitor Cm of the touch sensor TSU is changed and the change may be reflected to the sensing output signal to generate the output sensing signal. The sensing output electrode Rx and the sensing input electrode Tx may be positioned on the same plane in a section structure but may be positioned on different layers in another embodiment. When the sensing output electrode Rx and the sensing input electrode Tx are positioned on different layers, at least one portion may overlap each other. The sensing output electrode Rx and the sensing input electrode Tx may be made of transparent conductive materials such as indium tin oxide (ITO) and indium zinc oxide (IZO).

The sensing input electrodes Txs which are positioned in one row are electrically connected to the sensing input signal lines SL1 to SLp and each sensing output electrode Rx is electrically connected to the sensing output signal lines PL1 to PLk.

The sensing input signal lines SL1 to SLp and the sensing output signal lines PL1 to PLk may include a conductive material having resistance lower than that of the sensing input electrode Tx and the sensing output electrode Rx, for example, metal such as copper (Cu). The sensing input signal lines SL1 to SLp and the sensing output signal lines PL1 to PLk may also have a multilayer structure including at least two other conductive materials. The sensing input signal lines SL1 to SLp and the sensing output signal lines PL1 to PLk may be positioned on different layers. Here, the case in which the sensing input signal lines SL1 to SLp are positioned above the sensing output signal lines PL1 to PLk will be described.

The sensing output signal lines PL1 to PLk may be positioned on the output electrode Rx. The sensing output signal lines PL1 to PLk may extend in a column direction and each sensing output signal line PL1 to PLk may be connected to one corresponding sensing output electrode Rx by being contacted therewith

An insulating layer (not illustrated) is positioned on the sensing output signal lines PL1 to PLk. The insulating layer may include an organic insulating material or an inorganic insulating material. The insulating layer may include a touch hole Th which extends to and through which the sensing input electrode Tx is exposed.

The plurality of sensing input signal lines SL1 to SLp may be positioned on the insulating layer. The sensing input signal lines SL1 to SLp may extend in a row direction and may be electrically connected to the plurality of sensing input electrodes Tx which are arranged in a row direction through the touch hole Th. Therefore, the plurality of sensing input electrodes Txs which are arrange in a row direction are electrically connected to each other through one corresponding sensing input signal line SL1 to SLp. One sensing input electrode Tx and a portion of the sensing output electrodes Rx adjacent thereto may form one touch sensor TSU together.

The panel 500 may be bent in a concave or convex shape and thus the touched surface may not be flat.

The signal controller 100 may recognize a discontinuous touch timing among user touch drags. The signal controller 100 may recognize the recognized discontinuous touch timing as a continued touch drag depending on a predetermined condition. A touch recognition method of the signal controller 100 will be described below in detail.

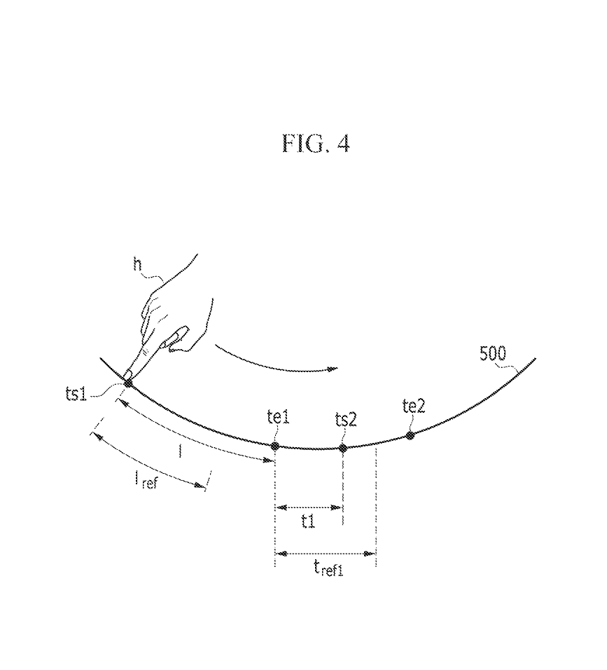

FIG. 4 is a front view illustrating a touch recognition method according to an exemplary embodiment.

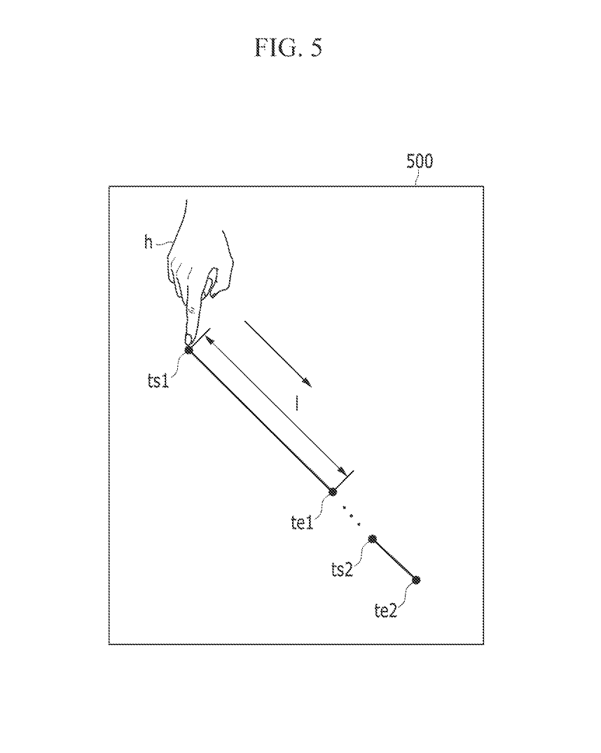

FIG. 5 is a plan view illustrating the touch recognition method according to the exemplary embodiment.

Hereinafter, the touch recognition method according to the exemplary embodiment will be described with reference to FIGS. 4 and 5.

As illustrated in FIG. 4, the signal controller 100 may sense a time when the sensor TSU of a user touch point h is touched, a touch drag length, a touch drag direction, a first touch starting timing ts1, a second touch starting timing ts2, a first touch ending timing te1, a second touch ending timing te2, and a first touch discontinuous period t1 based on the detection sensing signal (SS).

The first touch starting timing ts1 is a timing at which the user starts to first touch the touch sensor TSU. The first touch ending timing te1 is a timing at which a touch drag I continued for a predetermined time from the first touch starting timing ts1. is formed and then the user touch point h is separated from the touch sensor TSU. The second touch starting timing ts2 is a timing at which the touch sensor TSU is again touched after the first touch discontinuous period tI from the first touch ending timing te1. The second touch ending timing te2 is a timing at which a touch drag continued fora predetermined time from the second touch starting timing ts2 is formed and then the user touch point h is again separated from the touch sensor TSU.

As illustrated in FIGS. 4 and 5 the signal controller 100 may recognize the second touch ending timing te2 exceeding a first threshold time trefl. as a final touch point of the continued touch drag when the first touch discontinuous period t1 is equal to or less than the predetermined first threshold time tref1 and the continued touch drag I before the first touch ending timing te1 is equal to or more than a predetermined reference length lref. Describing in detail, the touch drag in which the user touch point h is continued from the first touch starting timing ts1 to the first touch ending timing te1 is generated in an arrow direction illustrated in FIGS. 4 and 5. Next, the touch drag in which the user touch point h is not touched for the first touch discontinuous period t1 from the first touch ending timing te1 to the second touch starting timing ts2. Then the touch drag continued from the second touch starting timing ts2 to the second touch ending timing te2 is generated. In this case, the signal controller 100 may recognize the discontinuous touch drag continued from the first touch starting timing ts1 to the second touch ending timing te2 as one continuous touch drag continued from the first touch starting timing ts1 to the second touch ending timing te2 when the first touch discontinuous period t1 is equal to or less than the predetermined first threshold time tref1 and the continued touch drag I is equal to or more than the reference length lref and recognize the second touch ending timing te2 as a final touch point.

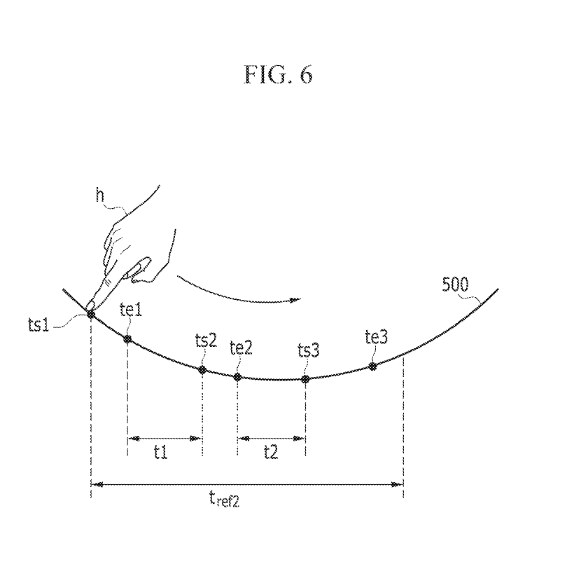

FIG. 6 is a front view illustrating a touch recognition method according to another exemplary embodiment.

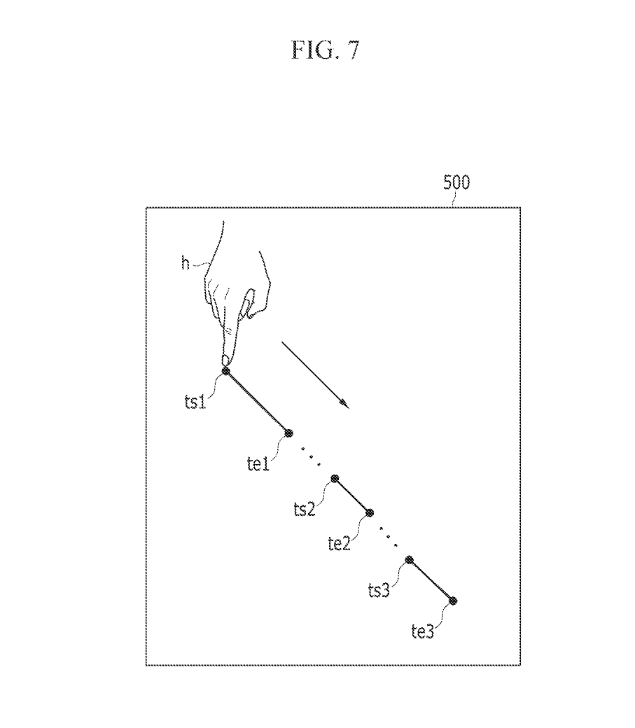

FIG. 7 is a plan view illustrating the touch recognition method according to another exemplary embodiment.

Hereinafter, a touch recognition method according to another exemplary embodiment will be described with reference to FIGS. 6 and 7.

As illustrated in FIG. 6, the signal controller 100 may use the sensing signal SS to sense the first to third touch starting timings ts1 to ts3, the first to third touch ending timings te1 to te3, the first touch discontinuous period t1, and the second touch discontinuous period t2 of the user touch point h.

The first touch starting timing ts1 is a timing at which the user starts to first touch the touch sensor TSU. The first touch ending timing te1 is a timing at which the touch drag continued for a predetermined time from the first touch starting timing ts1 is formed and then the user touch point h is separated from the touch sensor TSU. The second touch starting timing ts2 is a timing at which the touch sensor TSU is again touched after the first touch discontinuous period t1 from the first touch ending timing te1. The second touch ending time te2 is a timing at which a touch drag continued for a predetermined time from the second touch starting timing ts2 is formed and then the user touch point h is separated from the touch sensor TSU. The third touch starting timing ts3 is a timing at which the touch sensor TSU is again touched after the second touch discontinuous period t2 from the second touch ending timing te2. The third touch ending time te3 is a timing at which the touch drag continued for the predetermined time from the third touch starting timing ts3 is formed and then the user touch point h is again separated from the touch sensor TSU.

As illustrated in FIGS. 6 and 7, the signal controller 100 recognizes the discontinuous touch from the first touch starting timing ts1 to the third touch ending timing te3 as one continued (continuous) touch drag to recognize the third touch ending timing te3 as a final touch point, when the time from the first touch starting timing tst to the third touch ending timing te3 is equal to or less than the predetermined second threshold time tref2 and the touched frequency is substantially equal to or more than the reference frequency.

Describing in detail, the touch drag in which the user touch point h is continued from the first touch starting timing ts1 to the first touch ending timing te1 is generated in an arrow direction illustrated in FIGS. 6 and 7. Next, the touch drag in which the user touch point h is not touched for the first touch discontinuous period t1 from the first touch ending timing te1 to the second touch starting timing ts2. Then the touch drag continued from the second touch starting timing ts2 to the second touch ending timing te2 is again generated. Next, the user touch point h is not touched for the second touch discontinuous period t2 from the second touch ending timing te2 to the third touch starting timing ts3. Then the touch drag continued from the third touch starting timing ts3 to the third touch ending timing te3 is again generated. In this case, upon the condition below, the signal controller 100 disregards the first discontinuous period t1 and the second discontinuous period t2 and recognizes the periods t1 and t2 as one touch drag continued from the first touch starting timing ts1 to the third touch ending timing te3 to recognize the third touch ending timing te3 as the final touch point. The condition occurs when a total touch time from the first touch starting timing ts1 to the third touch ending timing te3 is equal to or less than the second threshold time tref2 and the touch frequency formed the first touch ending timing te1 form the first touch starting timing ts1, the second touch ending timing te2 from the second touch starting timing ts2, and the third touch ending timing te3 from the third touch starting timing ts3 is equal to or more than a predetermined reference frequency.

Hereinabove, FIGS. 4 to 7 describe an exemplary embodiment in which the touch drag is a straight line for convenience of explanation but the exemplary embodiment is not limited thereto. Further, the case in which the discontinuous period of the touch drag among all the touch drags is included once or twice is described but the exemplary embodiment is not limited thereto.

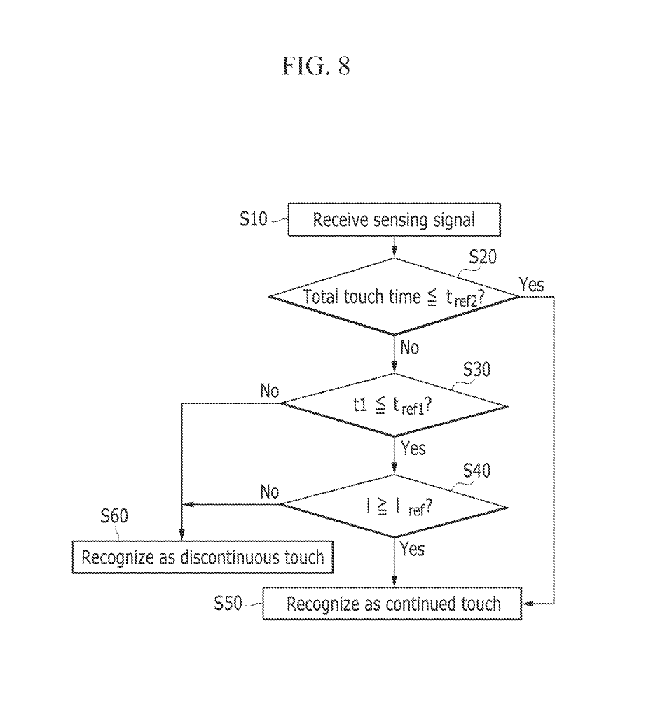

FIG. 8 is a flow chart illustrating a recognition method for a display device according to an exemplary embodiment.

In operation S10, the signal controller 100 may use the sensing signal SS to sense the first to third touch starting timings ts1 to ts3, the first to third touch ending timings te1 to te3, the first touch discontinuous period t1, and the second touch discontinuous period t2 of the user touch point h.

In operation S20, the signal controller 100 is determined whether the total touch time from the first touch starting timing ts1 to the third touch ending timing te3 is equal to or less than the second threshold time tref2.

When the total touch time is equal to or less than the second threshold time tref2, in operation S50, the signal controller 100 disregards the first touch discontinuous period t1 and the second touch discontinuous period t2 and recognizes the periods t1 and t2as one touch drag continued from the first touch starting timing ts1 to the third touch ending timing te3.

When the total touch time is not equal to or less the second threshold time tref2, in operation S30, the signal controller 100 determined whether the first touch discontinuous period t1 is equal to or less than the predetermined first threshold time tref1.

When the first touch discontinuous period t1 is equal to or less than the predetermined first threshold time tref1 in operation S40, the signal controller 100 determines whether the touch drag continued from the first touch starting timing ts1 to the first touch ending timing te1 is equal to or more than the reference length lref.

When the touch drag continued from the first touch starting timing ts1 to the first touch ending timing te1 is equal to or more than the reference length lref, the signal controller 100 recognizes the touch drag continued from the first touch starting timing ts1 to the first touch ending timing te1 as one touch drag continued from the first touch starting timing ts1 to the third touch ending timing te3.

When the first touch discontinuous period t1 is not equal to or less than the predetermined first threshold time tref1 or the touch drag continued from the first touch starting timing ts1 to the first touch ending timing te1 is not equal to or more than the reference length lref, in operation S60, the signal controller 100 recognizes the touch drag as the discontinuous touch.

White the inventive concept has been described in connection with what is presently considered to be practical exemplary embodiments, it is to be understood that the inventive concept is not limited to the disclosed embodiments, but on the contrary, is intended to cover various modifications and equivalent arrangements included within the spirit and scope of the appended claims. Therefore, the foregoing detailed description is not to be restrictively construed in all aspects but should be reckoned as being exemplary. The scope of the inventive concept is to be determined by a reasonable interpretation of the appending claims and all the changes within an equivalent range of the inventive concept are included in the scope of the inventive concept.

### <Description of Symbols>

100: Signal controller

200: Data driver

300D: Display scan driver

300T: Sensing scan driver

400: Sensing signal processor

500: Display panel

PX: Pixel

TSU: Touch sensor

What is claimed is:

1. A display device, comprising:
a display panel including a plurality of touch sensors;
a sensing signal processor configured to generate a sensing signal including whether the plurality of touch sensors are touched and a touch time; and
a signal controller configured to sequentially sense a first touch starting timing, a first touch ending timing, a second touch starting timing, and a second touch ending timing based on the sensing signal and configured to measure a first touch discontinuous period between the first touch ending timing and the second touch starting timing to recognize a touch,
wherein the signal controller is configured to recognize a touch from the first touch starting timing to the second touch ending timing as a continued touch when the first touch discontinuous period is equal to or less than a predetermined first threshold time.

2. The display device of claim 1, wherein:
the signal controller is configured to recognize a touch from the first touch starting timing to the second touch ending timing as the continued touch when a touch length from the first touch starting timing to the first touch ending timing is equal to or more than a reference length.

3. The display device of claim 2, wherein:
the second touch ending timing is sensed as exceeding the first threshold time, and
the signal controller is configured to recognize the touch from the first touch starting timing to the second touch ending timing as the continued touch.

4. The display device of claim 1, wherein:
the signal controller is configured to:
sequentially sense the first touch starting timing, the first touch ending timing, the second touch starting timing, the second touch ending timing, a third touch starting timing, and a third touch ending timing and measure the first touch discontinuous period and a second touch discontinuous period between the second touch ending timing and the third touch starting timing, and
recognize the touch from the first touch starting timing to the third touch ending timing as the continued touch when the first touch starting timing, the first touch ending timing, the first touch discontinuous period, the second touch starting timing, the second touch ending timing, the second touch discontinuous period, the third touch starting timing, and a third touch ending timing which are sequentially formed are equal to or less than a predetermined second threshold time.

5. The display device of claim 4, wherein:
the signal controller is configured to recognize the touch within a time from the first touch starting timing to the third touch ending timing as the continued touch when the first touch starting timing to the third touch ending timing which are sequentially sensed is equal to or more than a predetermined reference frequency.

6. The display device of claim 1, wherein:
the display panel is a flexible panel which is bent in a concave or convex shape.

7. A touch recognition method for a display device including a display panel including a plurality of touch sensors, a sensing signal processor generating a sensing signal including whether the plurality of touch sensors are touched and a touch time; and a signal controller recognizing a touch based on the sensing signal, the touch recognition method comprising:
sequentially sensing a first touch starting timing, a first touch ending timing, a second touch starting timing, and a second touch ending timing;
measuring a first touch discontinuous period between the first touch ending timing and the second touch starting timing; and
recognizing a touch from the first touch starting. timing to the second touch ending timing as a continued touch when the first touch discontinuous period is equal to or less than a predetermined first threshold time.

8. The touch recognition method of claim 7, wherein:
in the recognizing,
the touch from the first touch starting timing to the second touch ending timing is recognized as the continued touch when a touch length from the first touch starting timing to the first touch ending timing is equal to or more than a reference length.

9. The touch recognition method of claim 8, wherein:
the second touch ending timing is sensed as exceeding the firs threshold time, and
in the recognizing,
the touch from the first touch starting timing to the second touch ending timing is recognized as the continued touch.

10. The touch recognition method of claim 9, further comprising:
sensing a third touch starting timing and a third touch ending timing; and
measuring a second touch discontinuous period between the second touch ending timing and the third touch starting timing,
wherein in the recognizing,
the touch from the first touch starting timing to the third touch ending timing is recognized as the continued touch when the first touch starting timing, the first touch ending timing, the first touch discontinuous period, the second touch starting timing, the second touch ending timing, the second touch discontinuous period, the third touch starting timing, and a third touch ending timing which are sequentially formed are equal to or less than a predetermined second threshold time.

11. The touch recognition method of claim 10, wherein:
in the recognizing,
the touch within a time from the first touch starting timing to the third touch ending timing is recognized as the continued touch when the first touch starting timing to the third touch ending timing which are sequentially sensed is equal to or more than a predetermined reference frequency.

12. The touch recognition method of claim 7, wherein:
the display panel is a flexible panel which is bent in a concave or convex shape.
